(19) United States
(12) Patent Application Publication
(10) Pub. No.: US 2024/0035504 A1
(43) Pub. Date: Feb. 1, 2024

(54) Composite Material Rod and Fitting Assembly

(71) Applicant: LENTUS COMPOSITES LIMITED, Banbury Oxfordshire (GB)

(72) Inventor: MICHAEL DEWHIRST, Eynsham Oxfordshire (GB)

(21) Appl. No.: 18/255,750

(22) PCT Filed: Dec. 3, 2021
(86) PCT No.: PCT/GB2021/053163

§ 371 Date: Jun. 2, 2023

(30) Foreign Application Priority Data
Dec. 3, 2020 (GB) 2019048.4

(51) Int. Cl. F16B 7/02; B29C 65/64; B29C 65/56; B29C 57/04

(52) U.S. Cl. CPC F16B 7/025; B29C 65/64; B29C 65/565; B29C 57/04

(57) ABSTRACT

A method for securing a fitting 14 to a composite material rod 12, the method comprising forming a bore 20 in an end part of the rod 12, inserting a tool 26 into the bore 20 to cause radial expansion of the end part of the rod 12, inserting a retainer 22 into the expanded end part of the rod 12, and withdrawing the tool 26 from the end part of the rod 12, the retainer 22 serving to retain the end part of the rod 12 in an expanded condition. An assembly of a fitting 14 and composite material rod 12 is also described.

This invention relates to an assembly of a composite material rod with a fitting attached thereto, and to a method of attaching such a fitting to a composite material rod.

There are a number of applications in which it is desirable to use a composite material rod rather than, for example, a metallic material rod in the transmission of loads between a pair of components. The use of composite materials is advantageous in that the materials are typically of relatively low weight whilst still being able to bear significant tensile or compressive loads. Furthermore, depending upon the material used, thermal conduction can be restricted, and the materials can be of relatively low coefficient of thermal expansion. Whilst the use of composite materials is advantageous, one difficulty that is experienced when using such materials is that the attachment of fittings thereto, to allow the rod to be coupled to other components with which it is to be used is difficult as, for example, forming a screw thread on the rod, or drilling holes in the rod across the diameter thereof to allow the rod to be coupled to such fittings or directly to other components is difficult or not possible.

GB2452761 describes a method for attaching a fitting to an end of a composite material rod. In the arrangement of GB2452761, the fitting takes the form of a ferrule defining an internal passage of tapering form. An end part of the rod is split, and the split end part is located within the tapering internal passage of the ferrule. A tapered insert is then pushed into the split end of the rod, causing radial expansion of the rod so that the ferrule is held captive upon the rod. An adhesive is introduced into the split end of the rod, filling any spaces between the rod, the insert and the ferrule.

Whilst such an arrangement provides a relatively simple way to secure a fitting to an end of a composite material rod, it has disadvantages in that there is a need to split the end part of the rod prior to introduction of the rod into the ferrule, and storage and handling of such a split rod may carry the risk of the split rod being damaged. Also, the degree by which the rod can be expanded is limited by the presence of the ferrule, and this may result in the connection between the rod and the ferrule being unable to accommodate thermal expansion of the ferrule without the connection loosening, and this may restrict the range of applications in which the method may be used.

It is an object of the invention to provide an alternative technique by which a fitting may be secured to a composite material rod.

According to the present invention there is provided a method for securing a fitting to a composite material rod having a bore or passage in at least an end part thereof, the method comprising inserting a tool into the bore to cause radial expansion of the end part of the rod, inserting a retainer into the expanded end part of the rod, and withdrawing the tool from the end part of the rod, the retainer serving to retain the end part of the rod in an expanded condition.

The rod may be of solid form, with the bore or passage drilled or otherwise formed in the end part thereof. Alternatively, it could comprise a hollow tube or the like.

A fitting defining a passage including a relatively large diameter section and a smaller diameter section is preferably provided, the rod extending through the passage. The passage is conveniently of tapering form. Preferably, after expansion of the end part of the rod, the rod is moved relative to the fitting such that the cooperation between the relatively large diameter section of the passage and the expanded end part of the rod causes compression of the end part of the rod between the fitting and the retainer.

Preferably, a curable resin material is introduced into the bore to fill the bore and voids between the bore and the retainer.

Such an arrangement is advantageous in that there is no need to split the end of the rod prior to assembly, and so handling and storage issues associated with the use of pre-split rods are avoided. Furthermore, as the rod can be expanded to an outer maximum diameter that is larger than the diameter of the passage in the fitting, it will be appreciated that pre-stressing of rod with parts of the rod compressed between the retainer and the fitting can be achieved, such an arrangement being advantageous in that, for example, the rod and fitting can remain properly secured to one another despite thermal expansion or the like, in use, causing expansion of parts of the fitting.

According to a second aspect of the invention there is provided a method for securing a fitting to a composite material rod, the fitting defining a passage of a form having a relatively large diameter section and a smaller diameter section the method comprising, with an end part of the rod projecting from the fitting, inserting a tool into the rod to cause radial expansion of the end part of the rod and, after expansion of the end part of the rod, moving the rod relative to the fitting such that the cooperation between the relatively large diameter section of the passage and the expanded end part of the rod causes compression of the end part of the rod.

According to another aspect of the invention there is provided a composite rod and fitting assembly, the assembly comprising a fitting defining a passage of a form having a relatively large diameter section and a smaller diameter section, and a composite material rod, an end part of which is located within the passage, the end part of the rod being provided with a bore, the end part of the rod being of expanded diameter, a retainer located within the bore and retaining the end part of the rod in its expanded condition, the end part of the rod being compressed between the retainer and an adjacent part of the fitting.

Cured resin may be located within the bore, filling the bore and voids between the retainer and the end part of the rod.

The invention will further be described, by way of example, with reference to the accompanying drawings, in which:

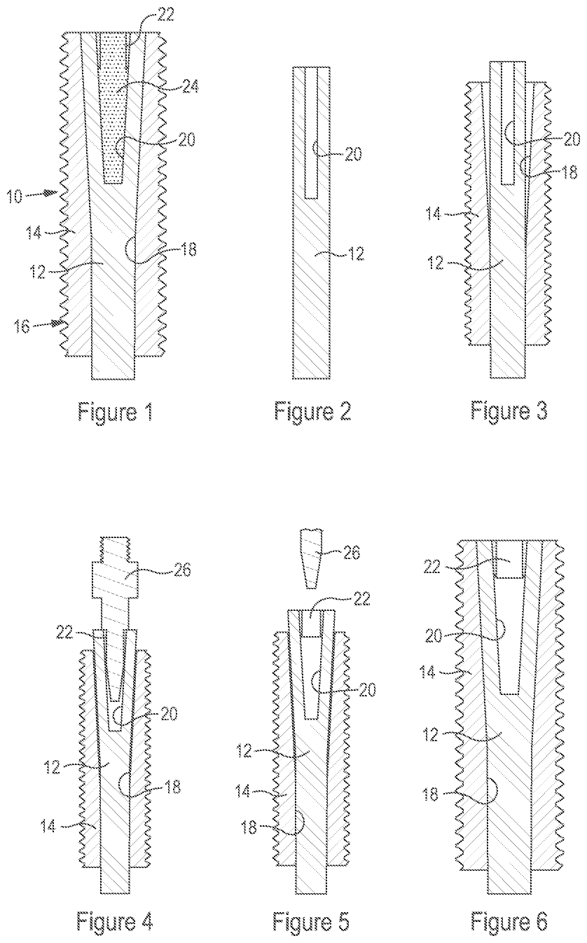

FIG. 1 is a diagrammatic representation of a composite rod and fitting assembly in accordance with an embodiment of the invention; and

FIGS. 2 to 6 are views illustrating steps in the method of assembling the assembly in accordance with an embodiment of the invention.

Referring firstly to FIG. 1 of the accompanying drawings, an assembly 10 of a composite material rod 12, for example formed by pultrusion and cut to a predetermined length, and a fitting 14 in the form of a ferrule of steel or another suitable metallic material is illustrated. The fitting 14 is of generally cylindrical form, formed on its outer surface with a screw thread formation 16, and defining an internal passage 18 that is of tapering form, having a relatively large diameter at one end of the fitting 14 and a smaller diameter at the other end of the fitting 14. Whilst a specific form of fitting 14 is illustrated, it will be appreciated that the invention is not restricted in this regard and that a number of modifications or alterations may be made to the shape or form thereof, save that the fitting 14 should include an internal passage 18 of a form having a relative large diameter portion and a smaller diameter portion.

The rod 12 includes an end part located within and extending through the passage 18 and provided with an axially extending bore 20. The part of the rod 12 including the bore 20 is of radially expanded form, as described below, and a retainer 22 is located within the bore 20, holding the end part of the rod 12 in its expanded condition. The retainer 22 is conveniently of metallic form, for example taking the form of a ring or tubular element of steel or another suitable material. However, the invention is not restricted in this regard and the retainer 22 may be of other forms and may be of other materials. By way of example, it could take the form of a suitable composite material element.

The remainder of the bore 20 is filled with a cured resin material element 24.

As illustrated, the part of the rod 12 of greatest diameter is located adjacent the larger diameter end of the passage 18, and it will be appreciated, as a consequence, that if the rod 12 is placed under tension by applying a load to the fitting 14 in a direction urging the fitting 14 from the end of the rod 12, the cooperation between the expanded part of the rod 12 and the passage 18 of the fitting 14 serves to retain the fitting 14 in position upon the rod 12.

FIGS. 2 to 6 illustrate steps in the process of assembling the assembly of FIG. 1. As shown in FIG. 2, the bore 20 is drilled or otherwise formed in the rod 12. By way of example, where the rod 12 is of 8 mm diameter, then the bore 20 may be of diameter in the region of 2-3 mm, for example of diameter 2.6 mm, and the depth of the bore 20 may be in the region of 25-30 mm, for example of depth 28 mm. The rod 12 is then inserted through the passage 18 of the fitting 14 and positioned such that the end of the rod 12 in which the bore 20 is formed projects from the passage 18 by a short distance, for example by around 5 mm, as shown in FIG. 3. It will be appreciated that the rod 12 and the bore 20 may have other dimensions.

Whilst it is convenient to drill the bore 20 before inserting the rod 12 into the passage 18, it will be appreciated that the order in which these steps are performed can be reversed, if desired. Likewise, the rod 12 may be of tubular form.

The end part of the rod 12 is next expanded by pushing a tool 26 into the bore 20, the tool 26 being of tapering form having a nose of diameter smaller than the initial diameter of the bore 20, and increasing in diameter to a size greater than the initial diameter of the bore 20, as shown in FIG. 4 so that as the tool 26 is pushed into the bore 20, the diameter of the rod 12 is expanded. Depending upon the degree by which the rod 12 is expanded in this process, and upon the material of the rod 12, the expansion of the rod 12 may result in tearing or splitting of the rod material during this process.

Prior to introduction of the tool 26 into the bore 20, the retainer 22 is fitted onto the tool 26. As illustrated in FIG. 4, the tool 26 may comprise a stepped abutment around part or all of its perimeter. The stepped abutment may limit, and practically prevent, axial sliding of the retainer 22 out of the bore 20 as the tool 26 is introduced into the bore 20. The stepped abutment may provide a seating surface that is wider than the bore 20, and thereby prevents over-insertion of the tool 26 into the bore 20. The tool 26 may comprise two stepped abutments around part or all of its perimeter, a first stepped abutment to hinder over-insertion of the tool 26, and, optionally, a second stepped abutment to limit the axial movement of the retainer 22. Upon introduction of the tool 26 into the bore 20, the retainer 22 is also inserted into the bore 20 so that, upon subsequent retraction and removal of the tool 26 from the bore 20, and slight contraction of the diameter of the end part of the rod 12 as a result of the inherent resilience thereof, the retainer 22 is retained within the end part of the bore 20 and serves to retain the end part of the rod 12 in a radially expanded condition, as shown in FIG. 5. In this position, the outer diameter of the end part of the rod 12 is greater than the inner diameter of the larger diameter part of the passage 18.

Next, as shown in FIG. 6, a load is applied to the rod 12 to push the rod 12 into the passage 18 to a position in which the end part thereof lies flush with the end of the fitting 14. The dimensions of the expanded end part of the rod 12 and the passage 18, and the cooperation therebetween, are such that as a result of such movement, the end part of the rod 12 becomes compressed between the retainer 22 and the fitting 14, the retainer 22 being designed in such a manner as to be able to bear the compressive loadings applied thereto as a consequence.

As shown in FIG. 1, a curable resin is applied to the bore 20, filling the bore 20 and any voids between the retainer 22 and the rod 12 and between the rod 12 and the fitting 14, and the resin is cured or allowed to cure to form the resin material element 24. The resin material element 24 serves to assist the retainer 22 in preventing radial contraction of the expanded end part of the rod 12.

The assembly and method of assembly are advantageous in that the need to handle and store rods with split end parts is avoided, and so the associated risks of damage and the like are avoided. Furthermore, and significantly, the invention allows the end part of the rod 12 to be compressed to a significant level between the fitting 14 and the retainer 22. As a consequence, if the fitting 14 expands, in use, for example as a result of thermal expansion if the assembly is being used at high temperatures, the pre-stressing of the end part of the rod 12 due to its compression between the fitting 14 and the retainer 22 allows the end part of the rod 12 to expand, maintaining contact with the fitting 14 and so maintaining the integrity of the connection between the rod 12 and the fitting 14. Where the retainer is of metallic form, then thermal expansion thereof may also assist in maintaining the integrity of the connection under such circumstances, and the retainer 22 may be designed and of a material chosen to enhance this effect.

Whilst in the description hereinbefore the rod 12 is of solid form, and the bore 20 is drilled or otherwise formed in just the end part thereof, it will be appreciated that the rod 12 could be of hollow, tubular form, if desired. In such an arrangement, the curable resin 24 may be omitted, or may fill the entirety of the passage provided in the rod 12, or a separate plug may be inserted into the passage as an initial step in the assembly process to contain the resin material prior to curing.

The invention may be used in a wide range of applications in which it is desired to be able to secure a fitting to an end part of a composite material rod, and the assembly may be used in a number of applications and is particularly suitable for use in applications in which the assembly is placed under tension, in use. If the composite material rod is of an electrically insulating material such as a suitable glass fibre reinforced rod, then the assembly may be used as an electrical insulator, for example for supporting electrical cables or equipment.

It will be appreciated that whilst a specific embodiment of the invention is described hereinbefore with reference to the accompanying drawings, a wide range of modifications and alterations may be made thereto without departing from the scope of the invention as defined by the appended claims.

1. A method for securing a fitting to a composite material rod including, at least at an end part thereof, a bore or passage, the method comprising:
inserting a tool into the bore to cause radial expansion of the end part of the rod;
inserting a retainer into the expanded end part of the rod; and
withdrawing the tool from the end part of the rod, the retainer serving to retain the end part of the rod in an expanded condition.

2. The method according to claim 1, wherein a fitting defining a passage including a relatively large diameter section and a smaller diameter section is provided, the rod extending through the passage.

3. The method according to claim 2, wherein the passage is of tapering form.

4. The method according to claim 2, wherein, after expansion of the end part of the rod, the rod is moved relative to the fitting such that the cooperation between the relatively large diameter section of the passage and the expanded end part of the rod causes compression of the end part of the rod between the fitting and the retainer.

5. The method according to claim 1, wherein a curable resin material is introduced into the bore to fill the bore and voids between the bore and the retainer.

6. The method according to claim 1, wherein the rod is of solid form, and the bore is drilled or otherwise formed in the end part thereof.

7. The method according to claim 1, wherein the rod is of hollow, tubular form.

8. A composite rod and fitting assembly, the assembly comprising a fitting defining a passage of a form having a relatively large diameter section and a smaller diameter section, and a composite material rod, an end part of which is located within the passage, at least the end part of the rod being provided with a bore or passage, the end part of the rod being of expanded diameter, a retainer located within the bore and retaining the end part of the rod in its expanded condition, the end part of the rod being compressed between the retainer and an adjacent part of the fitting.

9. The assembly according to claim 8, wherein cured resin is located within the bore, filling the bore and voids between the retainer and the end part of the rod.

10. The assembly according to claim 8, wherein the fitting is of metallic form.

11. The assembly according to claim 8, wherein the retainer is of metallic form.

12. The composite and rod assembly according to claim 8, wherein the rod is of solid form, and the bore is drilled or otherwise formed in the end part thereof.

13. The composite and rod assembly according to claim 8, wherein the rod is of hollow, tubular form.

14. A method for securing a fitting to a composite material rod, the fitting defining a passage of a form having a relatively large diameter section and a smaller diameter section the method comprising, with an end part of the rod projecting from the fitting, inserting a tool into the rod to cause radial expansion of the end part of the rod and, after expansion of the end part of the rod, moving the rod relative to the fitting such that the cooperation between the relatively large diameter section of the passage and the expanded end part of the rod causes compression of the end part of the rod.

15. The method according to claim 2, wherein the passage is of tapering form and wherein, after expansion of the end part of the rod, the rod is moved relative to the fitting such that the cooperation between the relatively large diameter section of the passage and the expanded end part of the rod causes compression of the end part of the rod between the fitting and the retainer.
